(19) United States
(12) Patent Application Publication
(10) Pub. No.: US 2025/0129739 A1
(43) Pub. Date: Apr. 24, 2025

(54) MOTORCYCLE HAVING AN INTERNAL COMBUSTION ENGINE WITH AN OUTPUT MEANS AND WITH A CHARGING DEVICE FOR THE INTERNAL COMBUSTION ENGINE

(71) Applicant: KTM AG, Mattighofen (AT)

(72) Inventor: Alexander Fürschuss, Klosterneuburg (AT)

(21) Appl. No.: 18/923,537

(22) Filed: Oct. 22, 2024

(30) Foreign Application Priority Data
Oct. 23, 2023 (DE) 10 2023 129 016.9

(51) Int. Cl. F02B 39/04; B62M 11/14; B62M 23/02; F02B 37/12; F02B 39/10

(52) U.S. Cl. CPC F02B 39/04; B62M 11/14; B62M 23/02; F02B 37/12; F02B 39/10

(57) ABSTRACT

A motorcycle is provided having an internal combustion engine with an output means and with a charging device for the internal combustion engine as well as a control device and an electric machine. The charging device has a compressor with a drive shaft, and has a transmission with a transmission input and a transmission output. The compressor is coupled in a force-fitting manner to the transmission output by the drive shaft. The transmission input is adapted to be driven by the electric machine or the output means, and a switchable clutch device is provided between the output of the internal combustion engine and the transmission input.

### CROSS-REFERENCE TO RELATED APPLICATIONS

This application claims priority to German Patent Application No. 10 2023 129 016.9, filed 23 Oct. 2023, the entire contents of which are incorporated herein by reference.

### BACKGROUND OF THE INVENTION

### Field of the Invention

The present invention relates to a motorcycle having an internal combustion engine with an output means and with a charging device for the internal combustion engine, as well as a control device and an electric machine.

### Background Information

Motorcycles having a charging device in the form of a compressor driven by the exhaust gas flow of the internal combustion engine of the motorcycle are already known. The purpose of the charging was to achieve high peak power. These types of motorcycles were able to provide the desired high peak power due to the critical response behaviour of the charging device in the form of a turbocharger, but were critical in terms of driving dynamics. The criticality was because the torque emitted suddenly by the internal combustion engine after the turbocharger had been activated was difficult to control; consequently, these motorcycles having turbocharging of the internal combustion engine fell into relative disfavor.

The development of the internal combustion engines used in motorcycles then led to the desired high peak power, which was achieved via a high rotational frequency level of the internal combustion engine. However, this in turn led to disadvantages regarding the efficiency of the internal combustion engine and the exhaust gas values emitted.

However, a goal of developing the internal combustion engine for motorcycles is to simultaneously achieve high engine efficiency and reduced exhaust gas values. Accordingly, there is a need to operate internal combustion engines with an operating strategy which has a combustion air ratio lambda of around one over the entire load and rotational frequency range, to improve the catalytic aftertreatment of the exhaust gases from the engine and reduce exhaust gas emissions.

The internal combustion engine is also intended to provide immediate torque for acceleration, for example during an overtaking maneuver, if the user so desires, while at the same time reducing power loss of the internal combustion engine in the form of friction losses and charge cycle losses.

A method for charging an internal combustion engine and a charging device for doing so are known from DE 10 2012 104 355 B4.

A compressor of a combustion engine is known from DE 10 2014 218 538 A1.

### SUMMARY OF THE INVENTION

This summary introduces selected basic concepts or features of the invention that are further described hereinbelow and is not intended to be limiting of the invention. An object of the present invention is to provide a motorcycle having an internal combustion engine and a charging device for the internal combustion engine which provides an immediate build-up of boost pressure when the rider so desires and, in particular, reduces the power loss of the internal combustion engine in the partial load range of the internal combustion engine.

The invention provides a motorcycle having an internal combustion engine with a drive means and with a charging device for the internal combustion engine, as well as a control device and an electric machine; the charging device has a compressor with a drive shaft and a transmission with a transmission input and a transmission output, and the compressor is coupled in a force-fitting manner to the transmission output by means of the drive shaft. The transmission input is driveable by means of the electric machine and/or the output means, wherein a switchable clutch device is provided between the output means of the internal combustion engine and the transmission input.

The charging device thus has a compressor which is mechanically driven by means of the drive shaft, and which serves to provide charge air for the internal combustion engine, i.e., to provide pressurized air for promoting the combustion process in the combustion chamber or combustion chambers of the internal combustion engine.

The drive shaft of the compressor is coupled in a force-fitting manner to the transmission output. The transmission output can therefore have an output shaft which is coupled in a force-fitting manner to the drive shaft of the compressor; alternatively, the compressor can be arranged directly on the output shaft of the transmission output, such that the rotary movement or rotary actuation of the transmission output or the output shaft of the transmission output ensures rotary actuation of the compressor, which can be a supercharger, for example. The rotary actuation of the compressor then ensures that air pressurized with boost pressure is present in the intake tract of the internal combustion engine and is available to the internal combustion engine for the combustion process.

According to an aspect of the invention, the transmission is a spur gear transmission having a plurality of transformation stages or is a planetary transmission. The spur gear transmission has the advantage of a cost-effective design of the transmission. The planetary transmission has the advantage of a compact solution respecting the required installation space, as well as the advantage that it can easily accomplish the rotational frequency spread or rotational frequency jump between the rotational frequency of the transmission input shaft and the rotational frequency of the transmission output shaft. It is to be assumed here that the transmission input shaft has a rotational frequency of around 4,000 revolutions per minute to around 15,000 revolutions per minute, for example, and that the rotational frequency of the drive shaft of the compressor is in the range of about 100,000 revolutions per minute to around 150,000 revolutions per minute.

According to an aspect of the invention, the output means is a traction mechanism stage or a gearwheel stage. The traction mechanism stage can be, for example, a chain drive or a toothed belt drive, such that a drive wheel for a toothed chain or another type of chain, or a drive pulley for a toothed belt, can be arranged on an output shaft of the internal combustion engine. The output shaft may be, for example, an output flange coupled to the crankshaft of the internal combustion engine or a crankshaft stub; a driven wheel for the chain or a driven pulley can be arranged on a driven input side of the clutch device.

With this configuration, the driven input side of the clutch device, which is acted upon by the internal combustion engine, is set in rotary motion. When the clutch device is closed, this rotary motion is then transmitted as a rotary motion to the transmission input shaft or the transmission input, thus introducing the rotary motion into the transmission and converting it at the output side of the transmission into a rotary motion with a high rotational frequency—which ultimately is used to drive the compressor in the form of a scroll compressor unit, for example, to build up boost pressure.

According to an aspect of the invention, the transmission input has a transmission input shaft, and the electric machine is coupled to the transmission input shaft in a rotationally fixed manner. This also includes a configuration according to which the electric machine is arranged directly on the transmission input shaft in a rotationally fixed manner, i.e., the electric machine or the electric motor is passed through by the transmission input shaft. The transmission input shaft can be rotatably mounted in a housing accommodating the aforementioned assemblies, and simultaneously represent the output shaft of the electric machine (thus achieving an extremely compact configuration).

According to an aspect of the invention, it is provided that, in a first operating state, the clutch device is closed, and the drive shaft of the compressor is driven via the transmission by means of the output means of the internal combustion engine. The motorcycle is adapted to supply the internal combustion engine with charge air pressurized by the compressor. In this first operating state, a first load path is therefore set, which is characterized in that the internal combustion engine drives the transmission input shaft at a first rotational frequency via the closed clutch device, which may also be referred to as a separating clutch, which is transformed into a second, higher rotational frequency by the transformation ratio of the transmission. The compressor, which can be a scroll compressor, is non-rotatably coupled to the transmission output shaft and is operated at the second, higher rotational frequency; the compressor then supplies the compressed charge air according to its rotational frequency, which is then made available to the internal combustion engine.

According to an aspect of the invention, it is provided that, in a second operating state, the clutch device is open and the drive shaft of the compressor, which is coupled to the transmission output shaft, is driven via the transmission, which is subjected to a rotational force on the input side by the electric machine. This second operating state is characterized in that the clutch device is open and the electric machine is controlled, for example via the control device, such that it delivers a drive torque to the transmission input shaft. The transmission input shaft thus rotates at a first rotational frequency, and this rotational frequency is transformed into a second, higher rotational frequency by means of the transmission due to the transformation ratio of the transmission, which then abuts the transmission output or transmission output shaft (i.e. the transmission output shaft rotates at the second, higher rotational frequency), and thus the compressor, which is coupled in a rotationally fixed manner to the transmission output shaft, operates at the second, higher rotational frequency.

This configuration corresponds, for example, to an operating state in which the internal combustion engine of the motorcycle is in a low rotational frequency range and therefore in a low power range. If, in such an operating state of the internal combustion engine, a rider request is detected that corresponds to a higher engine power output from the internal combustion engine—which is the case, for example, when the user of the motorcycle wishes to initiate an overtaking maneuver—the closed clutch device is opened and the compressor is driven by means of the electric motor or the electric machine in such a way that the rotational frequency of the transmission input shaft, which still corresponds to the output rotational frequency of the output means when the clutch device was closed, is significantly increased by the application of torque by means of the electric machine. This significantly increases the output rotational frequency of the transmission output shaft and thus also significantly increases the rotational frequency of the compressor. Consequently, in accordance with the driver's wish, the internal combustion engine is immediately supplied with a larger mass flow of charge air pressurized under higher boost pressure, which immediately increases the torque delivered by the internal combustion engine and thus also immediately provides more drive power to the internal combustion engine. This makes an overtaking maneuver substantially more dynamic.

The rotational frequency of the internal combustion engine thus also increases immediately, so that the rotational frequency of the output means of the internal combustion engine also increases immediately until the rotational frequency of the output means of the internal combustion engine corresponds to the rotational frequency of the transmission input shaft, which was accelerated by the electric machine. The open clutch device can therefore be closed, and from this point in time the drive of the compressor is taken over by the internal combustion engine—and thus the electric machine can be set to an operating state which differs from the operating state in which the electric machine drives the transmission input shaft.

According to an aspect of the invention, the motorcycle is adapted to maintain the second operating state with the clutch device open as the rotational frequency of the internal combustion engine increases until a predetermined rotational frequency of the internal combustion engine is reached, after which the clutch device is closed, and the electric machine is set to an operating state which differs from an operating state adapted to drive the compressor.

According to an aspect of the invention, the motorcycle is adapted to place the electric machine in an operating state in which it drives the compressor to provide compressed charge air, or to place it in a regenerative operating state in which it supplies an on-board power supply system of the motorcycle with electrical energy, or to place it in an operating state in which it provides drive power for driving the motorcycle (which is added to the drive power of the internal combustion engine for driving the motorcycle).

According to an aspect of the invention, the motorcycle is adapted to set the clutch device to an open state and the electric machine is set to a non-driven state when the aspirated-engine drive power of the internal combustion engine is sufficient to drive the motorcycle. This ensures that in an operating state or load state of the motorcycle, in which the internal combustion engine is operated in the aspirated engine state (i.e., without charging by the compressor, that is, sufficient power is provided by the internal combustion engine for this operating state), the motorcycle can set the switchable clutch device to an open state. The compressor is then not driven by the internal combustion engine and receives no drive power. In this state, the electric machine can also be set to a non-driven state. This means that, on one hand, the total friction losses of the internal combustion engine are reduced, meaning that the internal combustion engine requires less fuel and can therefore be operated in a consumption-optimised manner, and if the electric machine is also set to a non-driven state (i.e., does not drive the compressor and is not set to regenerative operation), the total energy consumption of the motorcycle is further reduced, as the regenerative operation of the electric machine does not require any drive power from the internal combustion engine.

If, for example, a load demand is then introduced into the motorcycle by the user of the motorcycle by operating the throttle twist grip of the motorcycle and this is detected, for example, by the control device, the control device can control the electric machine to drive the compressor in order to build up boost pressure. The internal combustion engine then immediately delivers additional power, the motorcycle is accelerated, the rotational frequency of the internal combustion engine increases up to the synchronisation point already mentioned above—at which the output rotational frequency of the output means matches the rotational frequency of the transmission input shaft driven by the electric motor or electric machine. The switchable clutch device can then be closed, and the compressor can continue to be driven by the internal combustion engine. The electric machine can be deactivated or switched to a regenerative operating state, for example, if the vehicle battery of the motorcycle needs to be charged via the on-board power supply of the motorcycle.

It is also possible to operate the electric machine by motor when the clutch device is closed to provide drive power for the compressor through the electric machine, which means that the otherwise necessary drive power for the compressor (which must be provided by the internal combustion engine) can be reduced. This means that the drive power otherwise required for the compressor is available for propelling the motorcycle, which means that an operating state of the motorcycle with maximum power or maximum acceleration can be provided.

According to an aspect of the invention, the motorcycle is adapted to adjust the rotational frequency of the drive shaft of the compressor with respect to the charge air requirement of the internal combustion engine by changing the output rotational frequency of the transmission output. This allows the performance curve of the compressor to be adapted to the engine aspiration characteristic.

According to an aspect of the invention, the motorcycle is adapted to detect an increased power requirement of the internal combustion engine triggered by a user of the motorcycle and, when the clutch device is open, to set the electric machine into an operating state which drives the compressor to provide compressed charge air, which increases the rotational frequency of the internal combustion engine until a predetermined rotational frequency range of the internal combustion engine is reached; the motorcycle is thus adapted to close the clutch device for driving the compressor by the drive means of the internal combustion engine when the rotational frequency range is reached. This ensures that in a purely aspirated-engine operating state, in which the compressor is not driven via the output means of the engine either and the electric motor is in a switched-off state or is operating regeneratively, for example, the electric motor is set to a drive state, in which it sets the scroll compressor or centrifugal compressor or, more generally, the compressor to a rotational frequency that builds up charge pressure, for example by means of the control device when the motorcycle rider requests power, for example by opening or further opening the throttle twist grip of the motorcycle. This also increases the rotational frequency of the internal combustion engine, wherein the clutch device can be closed at the above-mentioned synchronisation point and thus the compressor is further driven by the internal combustion engine itself, namely by means of the output means of the internal combustion engine.

According to an aspect of the invention, the motorcycle is adapted to control the clutch device for driving the compressor in such a way that the drive shaft of the compressor is driven via the transmission both by the electric machine and by the internal combustion engine. In this way, the aforementioned situation of maximum acceleration or maximum power of the internal combustion engine can be provided.

According to an aspect of the invention, the motorcycle also is adapted to determine the currently-required drive power of the internal combustion engine, which is dependent on the current driving state of the motorcycle, and to set the clutch device to an open state after determining that the current drive power provided in aspirated-engine operation of the internal combustion engine is sufficient to maintain the current driving state. This can increase the efficiency of the motorcycle, as the internal combustion engine no longer must provide drive power to maintain the operation of the compressor, which also helps to reduce the frictional power of the internal combustion engine.

According to an aspect of the invention, the clutch device is a clutch device that can be switched, in particular by an electric motor or electromagnetically. The clutch device or clutch must only fulfil the function of opening and closing, such that, for example, no operating state of slow rotational frequency adjustment of the driven and output side of the clutch is necessary (i.e., no operating state corresponding to a slipping of a friction clutch for rotational frequency adjustment is required).

The rotational frequency adjustment or rotational frequency synchronisation function may be provided by the electric machine, which is controlled accordingly by the control device of the motorcycle, for example. The clutch can therefore preferably be designed as an electromagnetically actuated clutch so that additional components for force-displacement control, as required for a friction clutch, are not necessary (but are possible).

According to an aspect of the invention, the control device is adapted to control the clutch device for opening and closing to implement the above-described actuation of the clutch to bring about an open or opened position and a closed position.

Finally, according to the invention, a motorcycle as described above is provided, which has a front wheel and a rear wheel and a rider's saddle.

### BRIEF DESCRIPTION OF THE DRAWINGS

The invention is explained in more detail below with reference to the drawing. This shows in:

FIG. 1 is a schematic representation of a motorcycle according to an embodiment of the present invention;

FIG. 2 is a schematic representation of a charging device of the motorcycle according to FIG. 1, wherein the charging device is shown in a first operating state;

FIG. 3 is a representation similar to that of FIG. 2, wherein the charging device is shown in a second operating state;

FIG. 4 is a representation similar to that of FIG. 2, wherein the charging device is shown in a third operating state; and

FIG. 5 is a diagram showing the compressor rotational frequency plotted against the engine rotational frequency of the internal combustion engine.

### DISCLOSURE OF THE SPECIFICATION

The present disclosure is of a motorcycle having an internal combustion engine and a charging device for the internal combustion engine which provides an immediate build-up of boost pressure when the rider so desires and, in particular, reduces the power loss of the internal combustion engine in the partial load range of the internal combustion engine.

The motorcycle has an internal combustion engine with a drive means and with a charging device for the internal combustion engine, as well as a control device and an electric machine. The charging device has a compressor with a drive shaft and a transmission with a transmission input and a transmission output, and the compressor is coupled in a force-fitting manner to the transmission output by means of the drive shaft. The transmission input is driveable by means of the electric machine and/or the output means, wherein a switchable clutch device is provided between the output means of the internal combustion engine and the transmission input. The charging device thus has a compressor which is mechanically driven by means of the drive shaft, and which serves to provide charge air for the internal combustion engine, thereby to provide pressurized air for promoting the combustion process in the combustion chamber or combustion chambers of the internal combustion engine.

The drive shaft of the compressor is coupled in a force-fitting manner to the transmission output. The transmission output can therefore have an output shaft which is coupled in a force-fitting manner to the drive shaft of the compressor; alternatively, the compressor can be arranged directly on the output shaft of the transmission output, such that the rotary movement or rotary actuation of the transmission output or the output shaft of the transmission output ensures rotary actuation of the compressor, which can be a supercharger. The rotary actuation of the compressor then ensures that air pressurized with boost pressure is present in the intake tract of the internal combustion engine and is available to the internal combustion engine for the combustion process.

Using a suitable transformation ratio between the transmission input and the transmission output, the rotational frequency of the transmission output or the rotational frequency of the output shaft of the transmission output can be scaled up, such that the compressor (for example the compressor blades of the compressor) can be driven at high rotational frequency.

In the configuration of the motorcycle, the transmission input (for example a transmission input shaft of the transmission), can be set in rotation by the electric machine on the one hand; but such rotation also can be by means of the output means of the internal combustion engine, such that the compressor can be driven by both the electric machine and by the internal combustion engine. A switchable clutch device is provided between the output means of the internal combustion engine and the transmission input, which can be closed or open depending on the desired operating mode of the compressor of the charging device. When the clutch device is closed, the internal combustion engine drives the transmission input, for example a transmission input shaft of the transmission input, by means of the output means; the rotational frequency of the transmission input shaft is scaled up by the transmission, i.e., increased by assemblies provided in the transmission such that the output shaft of the transmission (i.e., the transmission output) rotates at a higher rotational frequency than the drive shaft of the transmission.

Because the drive shaft of the compressor preferably is coupled to the output shaft of the transmission in a force-fitting manner, the increase in rotational frequency causes the compressor to rotate at a higher rotational frequency than the rotational frequency at the transmission input; the boost pressure in the intake tract of the internal combustion engine therefore increases. The compressor can be a scroll compressor, such that the elements or blades of the scroll compressor provided for boost pressure build-up ultimately rotate at a high rotational frequency and ensure the boost pressure build-up.

When the clutch device is open, the transmission input shaft is not driven by the output means of the internal combustion engine, i.e. set in rotation. The electric machine of the charging device, which acts directly on the transmission input, can therefore set the transmission input in rotary motion and thus set a transmission input shaft or drive shaft of the transmission in rotation at a first predetermined rotational frequency. This first predetermined rotational frequency can be converted into a higher, second predetermined rotational frequency by the transformation ratio or the spreading of the transmission, such that the output shaft or transmission output shaft (or, more generally, the transmission output of the transmission) rotates at a second predetermined rotational frequency; this then corresponds to the rotational frequency of the drive shaft of the compressor due to the force-fitting coupling of the drive shaft of the compressor to the transmission output. Thus, the elements or assemblies or blades of the compressor provided for the boost pressure build-up are driven at the second higher rotational frequency and thus the boost pressure is immediately available in the intake tract of the internal combustion engine.

The rotor assembly, or the elements, or the assemblies or blades of the compressor can be accelerated to the second predetermined rotational frequency in a very short time by energizing the electric machine; thus, further the boost pressure build-up in the intake tract of the internal combustion engine takes place in a very short time and thus an immediate boost pressure build-up occurs.

Therefore, even if the internal combustion engine is in a low rotational frequency range (that is, the output means of the internal combustion engine is also operating at a low rotational frequency and therefore the transmission input shaft of the transmission operates at a low rotational frequency when the clutch device is closed), an increase in rotational frequency by the transmission would not result in sufficient boost pressure in the intake tract of the internal combustion engine. That the clutch device is open or is opened in such an operating state of the internal combustion engine means that a strong acceleration of the transmission input shaft, a strong increase of the rotational frequency of the transmission input shaft, can be achieved in a short time by energizing the electric machine. Accordingly, the rotational frequency of the transmission output shaft increases in a short time due to the upscaling of the rotational frequency by the transmission, and thus the boost pressure prevailing in the intake tract of the internal combustion engine is to be increased in a short time. This means that the torque provided by the internal combustion engine increases significantly in a short time.

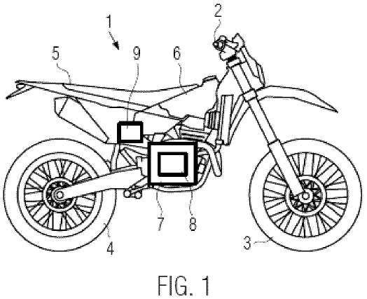

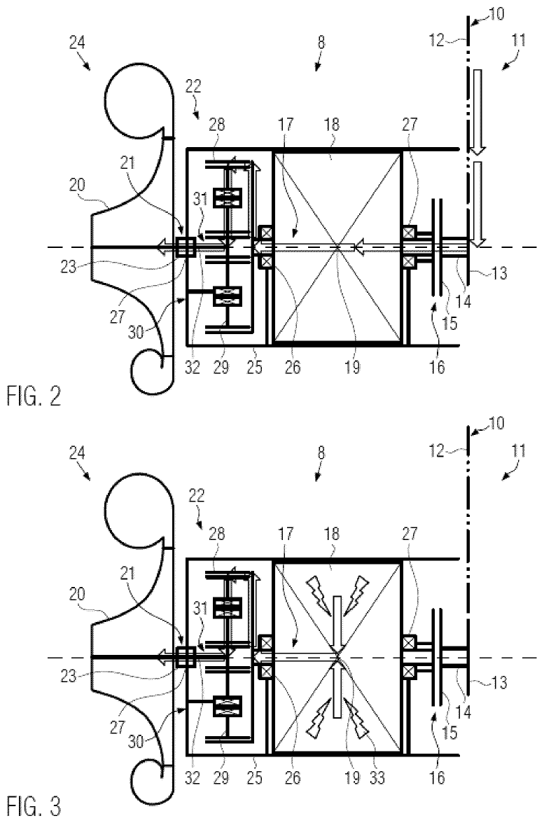

FIG. 1 of the drawing shows a schematic representation of a motorcycle according to an embodiment of the present invention. The motorcycle 1 has a front wheel 3, rear wheel 4, and a rider's saddle 5 as well as, among other things, a fuel tank 6 and a throttle twist grip 2. Additionally, the motorcycle has a schematically represented internal combustion engine 7 having a charging device 8 (represented schematically), and a control device 9, also represented schematically. The charging device 8 is shown in more detail in FIGS. 2-4.

The internal combustion engine 7 has an output means 10, which can be seen from FIG. 2, for example, and which in the embodiment shown is represented as a chain drive 11 having a chain 12. The chain 12 can be a toothed chain, for example, which is driven by a chain pinion not shown in more detail, which can be arranged on an output element of the internal combustion engine 7 (i.e., can be arranged in a rotationally fixed manner on an output shaft or on the crankshaft of the internal combustion engine 7, for example). The chain 12 driven in this way by the internal combustion engine 7 runs over a sprocket 13, which is arranged in a rotationally fixed manner on a shaft segment 14 or a shaft 14. The rotational force thus transmitted by the chain 12 is introduced by means of the shaft 14 into an input clement 15 of a switchable clutch device 16, which is arranged between the output means 10 and a transmission input 17.

The clutch device 16 is depicted in a closed position in FIG. 2, while FIG. 3 depicts the clutch device 16 in an open or opened position. In the closed position of the clutch device 16 according to FIG. 2, this transmits a rotational force into or onto the transmission input 17, and in the open or opened position of the clutch device 16, the transmission of the rotational force from the output means 10 to the transmission input 17 is interrupted. FIG. 2 of the drawing also shows that the charging device 8 has an electric machine or electric motor 18 which, in the depicted embodiment, is arranged in a rotationally fixed manner on the section 19 of the transmission input shaft 26 extending up to the electric machine 18. Alternatively, the electric machine 18 can also be arranged in a rotationally fixed manner on a compressor shaft or compressor drive shaft 21 of the compressor 20.

The transmission 22 depicted in the drawings is a planetary transmission, as this advantageously provides a solution in terms of the required installation space, the associated weight and the costs. Also, a planetary transmission 22 is also capable of converting the input rotational frequency of the transmission input 17 into a very high output rotational frequency of the transmission output 23 due to its high rotational frequency spreading.

In the depicted embodiment of the charging device 8, the transmission output 23 is coupled to the compressor drive shaft 21 in a rotationally fixed manner. In the depicted embodiment, the compressor 20 is a scroll compressor 24, wherein a compressor of a different design can also be employed in the invention. A scroll compressor has the advantage of a low-cost design, and the advantage of a relatively low rotational moment of inertia; the rotor assembly of the scroll compressor 24 (with the blades not depicted in detail) can therefore be accelerated to high rotational frequencies in a short time.

As can be seen from FIG. 2 to FIG. 4, the charging device 8 is arranged in a space-saving manner in a housing 25, which requires little installation space and is therefore designed for arrangement on the motorcycle 1 according to FIG. 1.

In the operating state of the clutch device 16 depicted in FIG. 2, it is closed for the transmission of rotational force from the output means 10 to the transmission input 17; the transmission input shaft 26, which is mounted in the housing 25 by means of two bearings 27, is driven in this operating state, which corresponds to a first load path, via the internal combustion engine 7, namely by means of the output means 10.

In this first operating state, the clutch device 16 is therefore closed and the drive shaft 21 of the compressor 20 is driven via the planetary transmission 22 by means of the output means 10 of the internal combustion engine. In this way, pressurized charge air is provided in the intake tract, not shown in more detail, of the internal combustion engine 7, which is made available to the internal combustion engine for combustion with fuel from the fuel tank 6—which is provided, for example, by means of an injection system, not depicted in more detail, of the internal combustion engine 7.

In the first operating state, the internal combustion engine 7 therefore drives the transmission input shaft 26 via the closed clutch device 16 at a first rotational frequency, which is converted by the planetary transmission 22 (which has a ring gear 28 and a planetary gear 29 as well as a planetary carrier 30 and a sun gear 31), into a significantly higher second rotational frequency and transmitted to the compressor drive shaft 21 via the transmission output 23. The output 23 has the transmission output shaft 32, such that the scroll compressor 24 can provide pressurized charge air in the intake tract of the internal combustion engine 7.

In the second operating state depicted in FIG. 3, the clutch device 16 is open, wherein the opening of the clutch device can be brought about, for example, by means of the control device 9, which actuates a switching element of the, for example, electrically switchable clutch device 16 to open the clutch device. In this second operating state, no rotational force is transmitted to the planetary transmission 22 via the clutch device 16. In the second operating state, the clutch device is open and the drive shaft of the compressor 20 is driven by means of the electric machine 18, as can be seen from the stylized current arrows 33 in FIG. 3. The motorcycle 1 is therefore adapted to supply the internal combustion engine 7 with charge air pressurized by the compressor 20.

If the internal combustion engine 7 is in a low rotational frequency range, wherein this low rotational frequency range is characterized in that the internal combustion engine 7 is operated in a pure aspirated-engine mode (i.e., no charge air is provided by the compressor 20), or is also characterized in that the clutch device 16 is closed, but the rotational frequency of the compressor 20 is set by means of the control device 9 in such a way that a low mass flow of charge air, or only charge air with a low pressure level, is provided, the situation may arise in which the rider of the motorcycle 1 wishes to carry out an overtaking maneuver, for example.

The rider initiates an overtaking manoeuvre by actuating the throttle twist grip 2 on the motorcycle 1 in such a way that the control device 9 derives a rider request from this, which requires higher power from the internal combustion engine 7 than it provided in the previous operating state—i.e., before the opening actuation of the throttle twist grip 2 by the rider of the motorcycle. The rider's request can be determined, for example, by monitoring the opening angle or angle of rotation of the throttle twist grip 2 of the motorcycle 1, or also by monitoring the speed at which the throttle twist grip 2 is opened by the rider of the motorcycle.

The control device 9 then controls the clutch device 16, if this was in a closed state, such that this clutch device 16 is opened, and after it has been established that the clutch device 16 is in the open state, the control device 9 controls the electric machine 18 such that this is energized and the transmission input shaft 26 is accelerated in a very short time to assume an increased rotational frequency. This energization of the electric motor or the electric machine 18 therefore results in the transmission output shaft 32 (and thus the drive shaft 21 of the compressor 24) being set to a very high rotational frequency in a short time due to the high transformation ratio of the planetary transmission 22; thus, the scroll compressor 24 in the intake tract of the internal combustion engine 7 provides charge air pressurized at high boost pressure, such that the drive power provided by the internal combustion engine 7 is increased in a short time. Accordingly, the rider's wish for increased drive power of the motorcycle is considered. By energizing the electric motor 18, the rotational frequency of the transmission input shaft 26 is therefore significantly increased in a short time, namely to a rotational frequency which is higher than the rotational frequency of the transmission input shaft 26 in the state of the transmission input shaft 26 driven by the internal combustion engine 7.

If the clutch device 16 was closed before the rider's request for increased engine power was detected, the transmission input shaft 26 therefore rotated at a lower rotational frequency than the rotational frequency of the transmission input shaft 26 after the clutch device 16 was opened and the transmission input shaft 26 was accelerated by the energization of the electric machine 18. The energization of the electric machine 18 therefore results in the rotational frequency of the transmission input shaft 26 overtaking the rotational frequency which is set due to the rotational actuation of the transmission input shaft 26 by the internal combustion engine 7. The internal combustion engine 7 is therefore supplied with boost pressure for the overtaking maneuver in accordance with the specific requirements of the internal combustion engine 7, the internal combustion engine 7 generates more drive power and the overtaking maneuver becomes more dynamic. The increase in the drive power of the internal combustion engine 7 also leads to an increase in the rotational frequency of the internal combustion engine, for example the crankshaft of the engine, on which a chain pinion (not depicted in more detail) of the chain drive 11 is arranged. This also increases the rotational frequency of the input element 15 of the clutch device 16.

The second operating state with the open clutch device can therefore be maintained as the rotational frequency of the internal combustion engine 7 increases until a predetermined rotational frequency of the internal combustion engine is reached, after which the clutch device is closed and it is possible to set the electric machine 18 to an operating state that differs from an operating state adapted to drive the compressor 20. When the load requirement is determined by the user of the motorcycle by actuating the throttle twist grip 2, the compressor 20 is thus set to a high rotational frequency increase by energizing the electric machine 18, the boost pressure increases. The internal combustion engine 7 then supplies more drive power and the motorcycle 1 accelerates. At the same time, the rotational frequency of the internal combustion engine increases up to a synchronization point at which the mechanical drive of the compressor 20 supplies the same boost pressure by means of the output means 10 and closed clutch device 16. At this point, the clutch device 16 can therefore be closed, and the electric drive of the compressor 20 may be deactivated by means of the electric motor or electric machine 18. It is therefore possible to switch off the electric machine 18 or to switch to a regenerative mode (for example to charge a battery of the motorcycle located in the on-board power supply system via the on-board power supply system of the motorcycle 1 if the charge status of the battery requires this).

The motorcycle 1 is therefore adapted to put the electric machine 18 in an operating state in which it drives the compressor 20 to provide compressed charge air or into a regenerative operative state in which it supplies an on-board power supply system of the motorcycle with electrical energy or also into an operating state in which it provides drive power to operate the motorcycle.

The electric machine 18 can therefore also be operated by a motor when the clutch device 16 is closed, the drive power of the internal combustion engine 7 required to drive the compressor 20 is thus reduced and this means that the drive power of the internal combustion engine 7 that is no longer required to drive the compressor 20 is available for the propulsion of the motorcycle 1; thus, a maximum power situation is achieved with which maximum acceleration of the motorcycle 1 can be achieved at the same time. Both the internal combustion engine 7 and the electric machine 18 provide power.

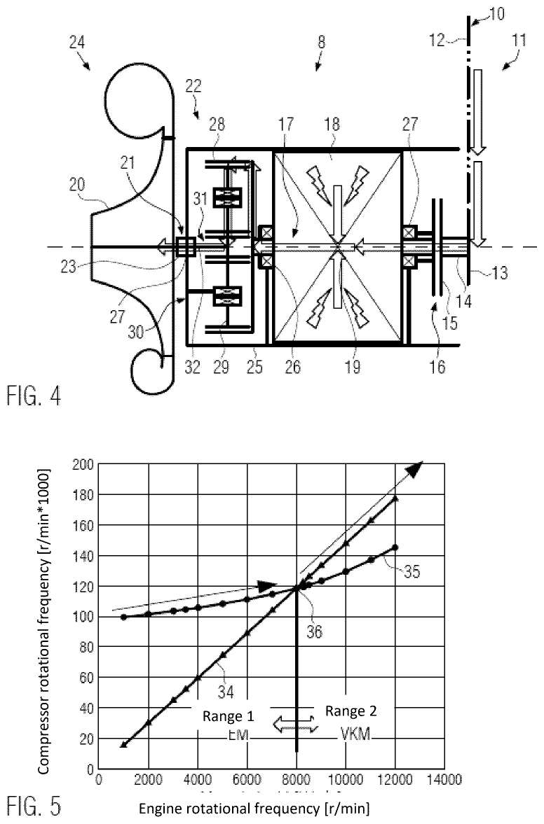

FIG. 4 shows this operating state in which the clutch device 16 is closed, i.e., drive power from the internal combustion engine 7 is transmitted via the output means 10 to the transmission input 17 and thus to the scroll compressor 24; drive power is also transmitted to the transmission input 17 via the electric machine 18, such that a boost function or over-boost function can be implemented.

FIG. 5 of the drawing shows a diagram which shows the compressor rotational frequency plotted against the engine rotational frequency of the internal combustion engine 7. The straight line 34 indicates a fixed rotational frequency ratio between the engine rotational frequency and the compressor rotational frequency.

A diagram is depicted which shows the run-up of the internal combustion engine 7 under full load. In the range labelled “range 1 EM”, the electric machine 18 is energized to accelerate the compressor 20 along the curve 35, which shows the rotational frequency requirement of the compressor 20 plotted against the engine rotational frequency of the internal combustion engine 7, such that the compressor 20 experiences a rotational frequency increase from 100,000 revolutions to approximately 118,100 revolutions in the embodiment depicted. The point of intersection 36 indicates the rotational frequency range of the internal combustion engine 7 of approximately 8000 revolutions per minute, at which the drive of the compressor 24 provides charge air or boost pressure via the transmission 22, which is driven by the output means 10 of the internal combustion engine 7; thus the electrically actuated or actuatable electric clutch device 16 can be closed and thus the electric machine 18 can be switched off or, for example, switched to regenerative operation to provide charging current for the vehicle battery of the motorcycle 1. This range is labelled “range 2 VKM” in the diagram according to FIG. 5.

A motorcycle according to the invention having an internal combustion engine is characterized by a charging device for the internal combustion engine, which on the one hand can be driven by the internal combustion engine itself by means of a mechanical output of the internal combustion engine, and on the other hand can also be driven by an electric machine or can be driven by both drive devices simultaneously. The charging device has a mechanically driven compressor in the form of a scroll compressor unit, for example, which is downstream of a transmission, the output side of which is driven by the aforementioned internal combustion engine and/or the electric machine; the transmission transforms the input rotational frequency of the transmission into a high output rotational frequency, with which the mechanically driven compressor is then driven directly.

If the motorcycle is operated in a partial load range of the internal combustion engine, the internal combustion engine can drive the compressor by means of the closed clutch device. The drive rotational frequency of the input side of the preferably used planetary transmission is scaled up by the planetary transmission to an output rotational frequency with which the compressor shaft of the mechanical compressor is then driven. In accordance with its rotational frequency, the compressor supplies the compressed charge air, which is made available to the internal combustion engine.

If the internal combustion engine is in a low rotational frequency range and the rider of the motorcycle wants to execute an overtaking maneuver, for example, the rider usually actuates the throttle twist grip on the handlebars of the motorcycle. The actuation is detected by the control device. The control device can then open the closed clutch device and simultaneously supply current to the electric machine, which then accelerates the input rotational frequency of the transmission input shaft and sets it to a higher input rotational frequency. This input rotational frequency of the transmission is scaled up by the planetary transmission and transformed into a significantly higher output rotational frequency at the transmission output side, which is fed directly into the compressor drive shaft. In this operating state, the electric machine drives the compressor so that the rotational frequency of the transmission input shaft brought about by the electric machine is higher than the prevailing rotational frequency of the transmission input shaft before the internal combustion engine was applied to the transmission input shaft. The compressor supplies the internal combustion engine with boost pressure as required, the internal combustion engine generates more power and the overtaking maneuver desired by the rider of the motorcycle becomes more dynamic.

At the same time, the rotational frequency of the crankshaft of the internal combustion engine increases and the increase in rotational frequency can take place up to a rotational frequency range at which the crankshaft of the internal combustion engine or an output means driven by the internal combustion engine has the same rotational frequency as an output element which acts on the transmission input shaft. When this equalization of rotational frequency occurs, the clutch device can be closed and the compressor can then be driven by the internal combustion engine by means of the output means, and the electric machine can be switched to another operating mode or switched off. The other operating mode can, for example, be a regenerative mode or a boost mode, in which the electric machine continues to cause the transmission input shaft to rotate, and thus drives the compressor or drives it together with the internal combustion engine. This reduces the drive work performed by the internal combustion engine to drive the compressor, and the internal combustion engine provides more power to propel the motorcycle.

In a mode or operating state with a closed clutch device, the electric machine coupled to the compressor drive shaft can also be operated regeneratively to supply the on-board power supply system of the motorcycle with electrical energy and, for example, to charge the motorcycle battery.

In an operating state of the motorcycle in which the internal combustion engine operates at low rotational frequency and low load and an aspirated-engine operation of the internal combustion engine provides sufficient power, it is advantageous to open the clutch device. This means that the compressor is at a standstill and does not receive any drive power. This also reduces the total frictional power of the internal combustion engine; the fuel consumption of the internal combustion engine is reduced. If a load request is made in such an operating state by the rider actuating the throttle twist grip, the compressor is highly accelerated by means of the electric machine in order to build up boost pressure. This can take place up to the synchronization point already mentioned above, at which the mechanical drive of the compressor supplies the same boost pressure that it delivers when electrically actuated; the electric drive can thus be deactivated or switched to regenerative operation.

The electric machine can also be engine-operated when the clutch device is closed, which reduces the drive power of the internal combustion engine for the compressor, more drive power of the internal combustion engine can be provided for accelerating the motorcycle, and maximum acceleration is achieved.

Although a planetary transmission was mentioned above as an embodiment of the transmission, it is possible to provide a multi-step transmission in the form of a spur gear transmission, for example, with several transformation stages. It is only necessary that the rotational frequency spreading of the transmission required to operate the compressor is provided. The clutch device is preferably an electrically switchable, i.e., electromagnetically actuated clutch, for example, as is known in the application of switchable air conditioning compressors.

The drive power provided by the internal combustion engine depends directly on the available boost pressure. An engine control unit, which can be, for example, the aforementioned control device, determines the required boost pressure for the desired target engine performance from sensor values, which correspond, for example, to the pressure and temperature prevailing in the intake air area of the internal combustion engine, the pressure and/or temperature prevailing in the combustion chamber of the internal combustion engine and/or in the exhaust gas system of the internal combustion engine (by means of sensors which the rotational frequency of the internal combustion engine, and the rider's request, which can be detected, for example, by the angle of rotation of the throttle twist grip of the motorcycle). Load- and rotational frequency-dependent control therefore takes place. Other parameters, such as the charge status of the motorcycle battery, for example, are also detected and used, for example, to decide whether and for how long the electric machine should be put into regenerative operation.

If the electric machine is to be set to regenerative operation, drive power from the internal combustion engine is required to drive the regeneratively operated electric machine. In such a case, the drive power of the internal combustion engine can be increased by the amount of drive power required for regenerative operation of the electric machine. This means that the drive power of the internal combustion engine is not perceptibly reduced for the rider of the motorcycle. When the motorcycle is in a driving state in which the drive power provided by the aspirated internal combustion engine is sufficient, i.e., without supercharging, the compressor is at a standstill and the electric machine is also in a switched-off state. If the motorcycle battery is to be charged in such a state, the clutch device can be closed after rotational frequency synchronisation between the input side and the output side of the clutch device, and the electric machine can be regeneratively operated.

In the starting phase of an internal combustion engine, which has not yet reached a sufficient temperature for exhaust gas aftertreatment in the exhaust gas system, so-called secondary air systems for supporting exhaust gas aftertreatment are advantageous. Such secondary air systems usually use an electrically operated air conveyor which conveys air into the exhaust gas system.

The motorcycle according to the invention is also characterized by the fact that the charging device can be used to convey more air than is required for the operation of the internal combustion engine by means of the electric machine in such an operating state after the internal combustion engine has started. This excess air can be fed to the exhaust gas system for exhaust gas aftertreatment with the aid of a control valve. A motorcycle according to the invention also is characterized in that it is possible to reduce the friction losses and charge cycle losses in the partial load range.

Because the compressor can be driven both mechanically and electrically, the torque curve provided by the internal combustion engine can be largely freely designed. It is also possible for the control device to provide driving program-dependent torque curves. The compressor can be set to standstill mode by means of the clutch device, that is, it can be driven neither by the internal combustion engine nor by the electric machine, which leads to a reduction in the fuel required by the internal combustion engine or the motorcycle. The on-board power supply system of the motorcycle can be energized via regenerative operation of the electric machine; an additional generator for charging the on-board power supply system is no longer required.

Compared to the purely electric operation of the compressor, the motorcycle according to the invention has the advantage that the compressor can be driven by the internal combustion engine as desired, and thus the motorcycle battery can be designed with a significantly smaller capacity compared to a system in which the compressor is only driven electrically, thereby also achieving a weight advantage of the motorcycle.

Regarding features of the invention not explained in more detail above, reference is also explicitly made to the claims and the drawing.

### REFERENCE NUMERAL LIST

1. Motorcycle
2. Throttle twist grip
3. Front wheel
4. Rear wheel
5. Rider's saddle
6. Fuel tank
7. Internal combustion engine
8. Charging device
9. Control device
10. Output means
11. Chain drive
12. Chain
13. Sprocket
14. Shaft segment, shaft
15. Input element
16. Switchable clutch device
17. Transmission input
18. Electric machine, electric motor
19. Section
20. Compressor
21. Compressor drive shaft
22. Planetary transmission, transmission
23. Transmission output
24. Scroll compressor
25. Housing
26. Transmission input shaft
27. Bearing
28. Ring gear
29. Planetary gear
30. Planetary carrier
31. Sun gear
32. Transmission output shaft
33. Current arrows
34. Straight line
35. Curve
36. Point of intersection

What is claimed is:

1. A motorcycle having:
an internal combustion engine with an output means, a charging device for the internal combustion engine, a control device, and an electric machine;
wherein the charging device has a compressor with a drive shaft and a transmission with a transmission input and a transmission output;
wherein the compressor is coupled in a force-fitting manner to the transmission output by means of the drive shaft, and the transmission input is adapted to be driven by means of the electric machine and/or the output means; and
wherein a switchable clutch device is provided between the output means of the internal combustion engine and the transmission input.

2. The motorcycle according to claim 1 wherein the transmission is a spur gear transmission having a plurality of transformation stages or is a planetary transmission.

3. The motorcycle according to claim 1 wherein the output means is a traction mechanism stage or a gearwheel stage.

4. The motorcycle according to claim 1 wherein the transmission input has a transmission input shaft, and the electric machine is coupled to the transmission input shaft in a rotationally fixed manner.

5. The motorcycle according to claim 4 wherein when in a first operating state the clutch device is closed and the drive shaft of the compressor is driven via the transmission by the output means of the internal combustion engine, and the motorcycle is adapted to supply the internal combustion engine with charge air pressurized by the compressor.

6. The motorcycle according to claim 5 wherein when in a second operating state the clutch device is open and the drive shaft of the compressor is driven by means of the electric machine, and the motorcycle is adapted to supply the internal combustion engine with charge air pressurised by the compressor.

7. The motorcycle according to claim 6 wherein the motorcycle maintains the second operating state with the clutch device open as the rotational frequency of the internal combustion engine increases until a predetermined rotational frequency of the internal combustion engine is reached, after which the clutch device is closed and the electric machine is set to an operating state which differs from an operating state adapted to drive the compressor.

8. The motorcycle according to claim 6 wherein the motorcycle is adapted to put the electric machine in an operating state in which it drives the compressor to provide compressed charge air or to put it in a regenerative operating state, in which it supplies an on-board power supply system of the motorcycle with electrical energy, or to put it in an operating state in which it provides drive power for driving the motorcycle which is added to the drive power of the internal combustion engine for driving the motorcycle.

9. The motorcycle according to claim 6 wherein the motorcycle is adapted to set the clutch device to an open state and to set the electric machine to a non-driven state when the aspirated-engine drive power of the internal combustion engine is sufficient to drive the motorcycle.

10. The motorcycle according to claim 6 wherein the motorcycle is adapted to adjust the rotational frequency of the drive shaft of the compressor to the demand for charge air of the internal combustion engine by changing the output rotational frequency of the transmission output.

11. The motorcycle according to claim 6 wherein the motorcycle is adapted to detect an increased power requirement of the internal combustion engine triggered by a user of the motorcycle and, when the clutch device is open, to set the electric machine to an operating state which drives the compressor to provide compressed charge air, which leads to an increase in the rotational frequency of the internal combustion engine until a predetermined rotational frequency range of the internal combustion engine is reached, and wherein further the motorcycle is adapted to close the clutch device for driving the compressor by the output means of the internal combustion engine when the rotational frequency range is reached.

12. The motorcycle according to claim 11 wherein the motorcycle is adapted to control the clutch device for driving the compressor such that the drive shaft of the compressor is driven via the transmission both by the electric machine and by the internal combustion engine.

13. The motorcycle according to claim 11 wherein the motorcycle is adapted to determine the currently required drive power of the internal combustion engine, which is dependent on the current driving state of the motorcycle, and to set the clutch device to an open state after determining that the current drive power provided in the aspiration-engine operation of the internal combustion engine is sufficient.

14. The motorcycle according to claim 13 wherein the clutch device is switchable by an electric motor.

15. The motorcycle according to claim 13 wherein the control device is adapted to control the clutch device for opening and closing.

16. The motorcycle according to claim 15, further comprising a front wheel, a rear wheel, a rider's saddle, and a throttle twist grip.
